(19) United States
(12) Patent Application Publication
(10) Pub. No.: US 2026/0003643 A1
(43) Pub. Date: Jan. 1, 2026

(54) PLUG-IN PROCESSING

(71) Applicant: Beijing Zitiao Network Technology Co., Ltd., Beijing (CN)

(72) Inventors: Weizhi YAN, Beijing (CN); Longteng PENG, Beijing (CN)

(21) Appl. No.: 18/984,584

(22) Filed: Dec. 17, 2024

(30) Foreign Application Priority Data
Jun. 30, 2024 (CN) 202410870005.3

(51) Int. Cl. G06F 9/445

(52) U.S. Cl. CPC G06F 9/44526

(57) ABSTRACT

A method for plug-in processing, a device, and a storage medium are provided. In the method, in response to receiving interaction information of a user from a client device, a call to a predetermined plug-in is determined based on the interaction information. The predetermined plug-in is configured to request execution of at least one function at the client device. In the method, a call parameter for a target function of the at least one function and a target communication connection mode with the client device are determined based on the interaction information. In the method, a communication connection is established with the client device based on the target communication connection mode, and the client device is requested to execute the target function with the call parameter via the communication connection.

### CROSS-REFERENCE

This application claims the benefit of Chinese Patent Application No. 202410870005.3 filed on Jun. 30, 2024, entitled “METHOD AND APPARATUS FOR PLUG-IN PROCESSING, DEVICE, STORAGE MEDIUM AND PROGRAM PRODUCT”, which is hereby incorporated by reference in its entirety.

### TECHNICAL FIELD

Example embodiments of the present disclosure generally relate to the field of computers, and more particularly, to plug-in processing.

### BACKGROUND

With the development of information technology, various client devices may provide various services for people in work and life. For example, the client device may be deployed with applications providing services. The client device or the application may provide digital assistant functions for the user to assist the user in using the client device or the application. How to improve functional diversity of digital assistants is a technical problem that is being explored.

### SUMMARY

In a first aspect of the present disclosure, a method for plug-in processing is provided. In the method, in response to receiving interaction information of a user from a client device, a call to a predetermined plug-in is determined based on the interaction information. The predetermined plug-in is configured to request execution of at least one function at the client device. In the method, a call parameter for a target function of the at least one function and a target communication connection mode with the client device are determined based on the interaction information. In the method, a communication connection is established with the client device based on the target communication connection mode, and via the communication connection, the client device is requested to execute the target function with the call parameter.

In a second aspect of the present disclosure, a method for plug-in processing is provided. In the method, in response to receiving interaction information of a user, the interaction information is sent to a server device. In the method, a corresponding communication connection is established with the server device based on a target communication connection mode. In the method, a call parameter for a target function at the client device is received from the server device via the communication connection, and the target function is executed based on the call parameter.

In a third aspect of the present disclosure, an electronic device is provided. The device includes at least one processing unit, and at least one memory. The at least one memory is coupled to the at least one processing unit and stores instructions for execution by the at least one processing unit that, when executed by the at least one processing unit, cause the electronic device to perform operations that implement the method of the first aspect or the method of the second aspect.

In a fourth aspect of the present disclosure, a computer readable storage medium is provided. The medium has a computer program stored thereon, and when the computer program is executed by a processor, operations that implement the method of the first aspect or the method of the second aspect are performed.

In a fifth aspect of the present disclosure, a computer program product is provided. The product includes a computer program that, when executed by a processor, the method according to the first aspect or the second aspect of the present disclosure is performed.

It should be understood that what is described in this section is not intended to limit the critical features or essential features of the embodiments of the present disclosure, nor is it intended to limit the scope of the present disclosure. Other features of the present disclosure will be readily appreciated from the following description.

### BRIEF DESCRIPTION OF THE DRAWINGS

These and other aspects and advantages of embodiments of the present disclosure will become apparent and more readily appreciated from the following descriptions made with reference to the drawings. In the drawings, the same or similar reference numerals indicate the same or similar elements, in which:

FIG. 1 illustrates a schematic diagram of an example environment. in which embodiments of the present disclosure may be implemented;

FIG. 2 illustrates a flowchart of an example signaling flow for plug-in processing.

FIG. 3 illustrates a flowchart of an example signaling flow for plug-in processing.

FIG. 4 illustrates a flowchart of an example signaling flow for plug-in processing.

FIG. 5 illustrates a flowchart of an example process for plug-in processing.

FIG. 6 illustrates a flowchart of an example process for plug-in processing.

FIG. 7 illustrates an example structural block diagram of an apparatus for plug-in processing.

FIG. 8 illustrates an example structural block diagram of an apparatus for plug-in processing.

FIG. 9 illustrates a block diagram of an electronic device in which one or more embodiments of the present disclosure may be implemented.

### DETAILED DESCRIPTION

Embodiments of the present disclosure will be described in more detail below with reference to the accompanying drawings. Although certain embodiments of the present disclosure are illustrated in the accompanying drawings, it should be understood that the present disclosure may be implemented in various forms and should not be construed as limited to the embodiments set forth herein, but rather, these embodiments are provided for a thorough and complete understanding of the present disclosure. It should be understood that the drawings and embodiments of the present disclosure are only for illustrative purposes and are not intended to limit the scope of the present disclosure.

In the description of the embodiments of the present disclosure, the term “including” and the like are to be understood as open inclusion, i.e., “including but not limited to”. The term “based on” should be understood as “based at least in part”. The term “one embodiment” or “the embodiment” should be understood as “at least one embodiment”. The term “some embodiments” should be understood as “at least some embodiments”. Other explicit and implicit definitions may also be included below.

In this specification, unless explicitly stated, performing a step “in response to A” does not mean that the step is performed immediately after “A”, but may include one or more intermediate steps.

It will be appreciated that the data (including but not limited to the data itself, data acquisition, use, storage, or deletion) involved in the technical solutions of the present disclosure should comply with the requirements of the corresponding laws, regulations and relevant provisions.

It should be understood that, before the technical solutions of the embodiments of the present disclosure are used, the relevant users should be informed of the type, the usage scope, the usage scenario of the information in an appropriate manner according to relevant laws and regulations, and authorization of the relevant users should be obtained. The relevant users may include any type of entitlement bodies, such as individuals, enterprises, and groups.

For example, in response to receiving an unsolicited request from a user, prompt information is sent to the relevant user to explicitly remind the relevant user that the operation requested to be executed will need to obtain and use information of the relevant user, such that the relevant user may autonomously select, according to prompt information, whether to provide information for software or hardware (such as an electronic device, an application, a server, or a storage medium) that executes the operation of the technical solutions of the present disclosure.

As an optional but non-limiting implementation, in response to receiving an unsolicited request from the relevant user, for example, the prompt information may be sent to the relevant user by a pop-up window, and the prompt information may be presented in the form of text in the pop-up window. In addition, the popup window may also carry a selection control for the user to select ‘agree’ or ‘don't agree’ to provide information to the electronic device.

It should be understood that, the above notifying and obtaining the user authorization process are merely examples, and do not limit the implementation of the present disclosure, and other methods meeting relevant laws and regulations may also be applied to the implementation of the present disclosure.

As used in this specification, the term “model” is referred to as an association between an input and an output learned from training data, and thus a corresponding output may be generated for a given input after the training. The generation of the model may be based on a machine learning technique. Deep learning is a machine learning algorithm that processes inputs and provides corresponding output by using a multi-tiered processing unit. Neural network model is an example of a model based on deep learning. As used herein, “model” may also be referred to as “machine learning model”, “learning model”, “machine learning network”, or “learning network,” which are used interchangeably herein.

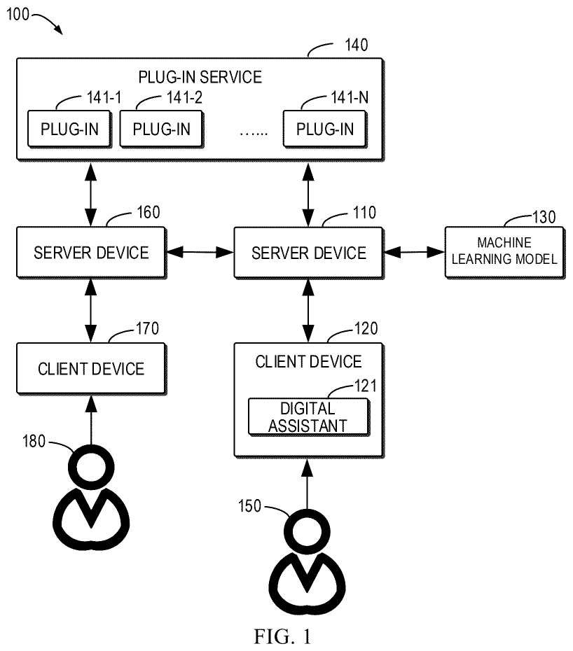

FIG. 1 illustrates a schematic diagram of an example environment 100 in which embodiments of the present disclosure may be implemented. The environment 100 relates to client devices 120, 170, server devices 110, 160, the machine learning model 130, and the plug-in service 140.

As illustrated in FIG. 1, a client device 120 may be deployed with a digital assistant 121. The user 150 may interact with the digital assistant 121 through the client device 120 or the attachment device of the client device 130. The digital assistant 121 is provided to assist the user 150 in handling various types of task processing requirements in different applications and scenarios. The digital assistant 121 typically has intelligent conversation and task processing capabilities. During the interaction with the digital assistant 121, the user 150 may enter the interaction message (e.g., conversation content in text, voice, image, video, or other modalities), and the digital assistant 121 may respond to the user input by providing a reply message. In general, the digital assistant 121 may allow the user 150 to enter questions in a natural language format and perform tasks and provide responses based on the digital assistant's understanding and logical reasoning capabilities for natural language input.

In some embodiments, the digital assistant 121 supports the use of one or more plug-ins 141. Each plug-in 141 is capable of providing one or more functions of the application. The one or more plug-ins 141 may include, but are not limited to, one or more of a search plug-in, a contact plug-in, a message plug-in, a document plug-in, a table plug-in, a mail plug-in, a calendar plug-in, a schedule plug-in, a task plug-in, and the like.

In some embodiments of the present disclosure, the plug-in service 140 provides the user 150 and user 180 with the creation, publishing, saving, and application environments of the plug-in 141. The plug-in service 140 may be deployed with, for example, a database to store the created plug-in 141. For example, the plug-in service 140 may store a plurality of plug-ins 141 such as the plug-in 141-1, the plug-in 141-2, . . . , the plug-in 141-N.

The server device 160 may be deployed with a plug-in creation platform. The plug-in creation platform may provide a set of tools required for creating the plug-in 141. The plug-in creation platform may support visual development of the plug-in 141. The plug-in creation platform may support any suitable platform for a user development interface. For example, the client device 170 may be deployed with a client program of the plug-in creation platform. The client program may support the interaction between the user 180 and the plug-in creation platform. The plug-in creation platform may interact with plug-in service 140 to enable the creation of plug-in 141.

A plug-in application platform may be deployed at the server device 110. The plug-in application platform may interact with the plug-in service 140 to call the plug-in 141. After the plug-in 141 is created, the user 150 may input the conversation message in the conversation window of the digital assistant 121. The digital assistant 121 may request the plug-in service 140 to assist in calling the plug-in 141 based on the plug-in definition of the plug-in 141, and obtain feedback information from the plug-in 141. The digital assistant 121 may determine the reply message based on the feedback information and present it to the user in the conversation window.

In some embodiments, the digital assistant 121 may support the interaction with the user 150 by utilizing the machine learning model 130. For example, the digital assistant 121 may utilize one or more machine learning models 130 to provide question-answer services to the user 150.

In some embodiments, the one or more machine learning models 130 may be constructed based on a language model (LM). The machine learning model used is a content generating model, which may generate the corresponding output based on the model input. In some embodiments, the machine learning model based on the language model is capable of processing text-modality model input (e.g., natural language and/or machine language) and/or non-text-modality model input (e.g., images, speech, video, etc.), and generating the desired output based on the model input and the prompt. The prompt here is used to guide the machine learning model to generate the output that may address the user's needs indicated by the model input. In the application scenario for supporting the user conversation, the user input may be provided to the machine learning model 130 as at least a portion of the model input (other portions may include the prompt). The user input is regarded as the question. Based on the model output, a corresponding reply may be generated and provided to the user 150.

In some embodiments, the client device 120 communicates with server device 110 to enable the provision of services to the digital assistant 121. As illustrated in FIG. 1, the server device 110 may call the machine learning model 130 to support the human-machine conversation function between the digital assistant and the user 150 based on the output of the machine learning model 130.

The client devices 120, 170 may be any suitable type of mobile terminal, fixed terminal, or portable terminal, including mobile phones, desktop computers, laptops, netbooks, tablets, media computers, multimedia tablets, personal communication system (PCS) devices, personal navigation devices, personal digital assistants (PDAs), audio/video players, digital cameras/camcorders, positioning devices, television receivers, radio broadcast receivers, e-book devices, gaming devices, or any combination thereof, including accessories and peripherals of these devices or any combination thereof. In some embodiments, the client devices 120, 170 may also support any suitable type of user specific interface (such as “wearable” circuitry, etc.). Here, the client device 120 and the client device 170 may be implemented as the same client device, or may be implemented as different client devices.

The server devices 110, 160 may be various types of computing systems/servers capable of providing computing capabilities including, but not limited to, mainframe computers, edge computing nodes, computing devices in a cloud environment, etc. The server devices 110 and 160 may be implemented, for example, based on a cloud environment. The server device 110 and the server device 160 may also be implemented as the same server device, or may be implemented as different server devices.

It should be understood that the structures and functions of the various elements in the environment 100 are described for exemplary purposes only, and are not intended to imply any limitation on the scope of the present disclosure.

As mentioned above, with the development of information technology, various client devices may provide various services for people in work and life, etc. For example, the client device may be deployed with applications providing services. The client device or the application may provide digital assistant functions for the user, to assist the user in using the client device or the application.

In order to improve the functional diversity of the digital assistant, some developers have configured the digital assistant to support the use of plug-ins. Each of the plug-ins may provide one or more functions. The digital assistant may call the corresponding plug-in to provide services to the user according to the user's needs.

In the related art, the digital assistant generally provides the service to the user based on feedback information of the plug-in. However, the plug-in generally may not operate the client device, which limits function expansion and service capability of the digital assistant to a certain extent.

In view of this, according to embodiments of the present disclosure, a solution for plug-in processing is provided. According to the solution of the embodiments of the present disclosure, in response to receiving interaction information of the user from a client device, a call to a predetermined plug-in is determined based on the interaction information. The predetermined plug-in is configured to request execution of at least one function at the client device. Based on the interaction information, a call parameter for a target function of the at least one function and a target communication connection mode with the client device are determined. Based on the target communication connection mode, a communication connection with the client device is established. Via the communication connection, the client device is requested to the target function with the call parameter.

In this way, in the plug-in calling scenario, the plug-in may be used to request the client device to execute the target function, thereby being beneficial for expanding the usage function and the service capability of the digital assistant.

Some example embodiments of the present disclosure will be described below with continued reference to the accompanying drawings.

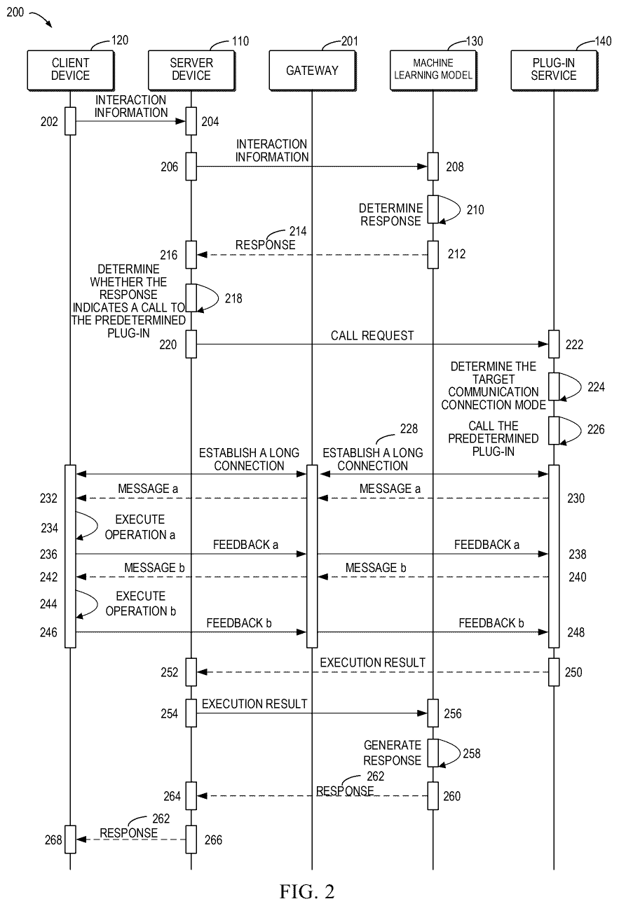

FIG. 2 illustrates a flowchart of a signaling flow 200 for plug-in processing according to some embodiments of the present disclosure. The signaling flow 200 involves the client device 120, the server device 110, a gateway 201, the machine learning model 130, and the plug-in service 140. For ease of discussion, the signaling flow 200 will be described with reference to the environment 100 of FIG. 1.

In some embodiments of the present disclosure, as illustrated in the signaling flow 200, in response to receiving the interaction information of the user 150, the client device 120 sends (202) the interaction information to the server device 110. In response to receiving (204) the interaction information of the user 150 from the client device 120, the server device 110 provides (206) the interaction information to the machine learning model 130. In response to receiving (208) the interaction information provided by the server device 110, the machine learning model 130 determines (210) a response 214 to the interaction information, and provides (212) the response 214 to the server device 110.

The interaction information here may include various types of information input by the user 150, such as text information, voice information, image information, video information, or information of other modalities. Before the client device 120 sends the interaction information to the server device 110, the client device 120 may establish the communication connection (such as the long connection or the short connection conforming to a transmission control protocol (TCP)) with the server device 110, and send the interaction information to the server device 110 via the established communication connection.

Alternatively, or additionally, after the server device 110 receives the interaction information from the client device, the server device 110 may construct the model input of the machine learning model 130 based on the interaction information, and provide the model input to the machine learning model 130. The machine learning model 130 may generate the response 214 to the interaction information based on the model input.

Here, the machine learning model 130 may determine, based on the model input, whether there is a need to call the predetermined plug-in to request execution of at least one function at the client device 120. When the machine learning model 130 determines that there is no need to call the predetermined plug-in, it may generate the response to the interaction information. For example, the machine learning model 130 may generate the response text to the question of the user 150. In this case, the server device 110 may provide the response to the client device 120. When the machine learning model 130 determines that there is a need to call the predetermined plug-in (e.g., at least one plug-in of plug-ins 141-1, 141-2, . . . , 141-N) to request execution of at least one function at the client device 120, the machine learning model 130 may determine, based on the interaction information, the call parameter for the target function of the at least one function and the target communication connection mode with client device 120.

The at least one function at the client device 120 here may include various functions that may be executed by the client device 120, such as volume adjustment, screen brightness adjustment, network control, turning on or turning off Bluetooth, turning on or turning off a hotspot, device mode adjustment, turning on a specific application of the client device 120, etc. The specific type of the at least one function at the client device 120 is not limited herein. The target function may be any one of the various functions (such as turning on or turning off Bluetooth, turning on or turning off a hotspot, etc.) that may be executed by the client device 120. Accordingly, the predetermined plug-in is configured to request the client device 120 to execute at least one of the various functions that may be executed by the client device 120. For example, the predetermined plug-in may be configured to request the client device 120 to execute the volume adjustment function, the screen brightness adjustment function, and the like.

Alternatively, or additionally, the call parameter may include the function identification, one or more input parameters, and one or more output parameters. The input parameter here may include information that needs to be carried for executing the target function. For example, the output parameter may include information that is generated or returned after the execution of the target function is completed. The function identification may be configured to identify the target function module (e.g., a system call interface, an application program interface, a function, etc.) executing the target function at the client device.

Alternatively, or additionally, the target communication connection mode is configured to indicate the communication connection mode between the predetermined plug-in and the client device 120. The target communication connection mode may include, but is not limited to, the long connection and the short connection conforming to the TCP protocol. Certainly, the foregoing communication connection modes are only examples, and in practical applications, the communication connection mode may be flexibly selected according to practical requirements.

In some embodiments of the present disclosure, as illustrated in the signaling flow 200, the server device 110 receives (216) the response 214 from the machine learning model 130. The server device 110 determines (218) whether the response 214 indicates a call to the predetermined plug-in. When the response 214 includes the call indication of the predetermined plug-in, the call parameter for the target function of the at least one function and the target communication connection mode with client device 120, the server device 110 sends (220) the call request to the plug-in service 140.

Alternatively, or additionally, the server device 110 may determine whether the response 214 includes the call indication for the predetermined plug-in. When the response 214 includes the call indication for the predetermined plug-in, the server device 110 may determine that the response 214 indicates the call to the predetermined plug-in. When the response 210 does not include the call indication for the predetermined plug-in, the server device 110 may determine that response 214 does not indicate the call to the predetermined plug-in. The server device 110 may also determine whether the response 214 includes the call parameter for the target function and/or the target communication connection mode with client device 120. When the response 214 includes the call parameter and/or the target communication connection mode, it may be determined that the response 214 indicates the call to the predetermined plug-in. When the response does not include the call parameter and the target communication connection mode, it may be determined that response 214 does not indicate the call to the predetermined plug-in. It may be understood that the call instruction here is not necessarily required. In practical applications, the call to the predetermined plug-in may also be identified in other ways.

Alternatively, or additionally, the call request may include the call parameter of the target function and the communication identification of the target communication connection mode (e.g. the identification for identifying the long connection or the short connection). The call request may further include the plug-in identification (such as the plug-in name, the plug-in number, and the plug-in address of the predetermined plug-in) for identifying the predetermined plug-in.

In some embodiments of the present disclosure, as illustrated in signaling flow 200, in response to receiving (222) the call request from server device 110, the plug-in service 140 determines the target communication connection mode between the predetermined plug-in and the client device 120. When the target communication connection mode indicates the long connection mode, the plug-in service 140 establishes (228) the long connection corresponding to the long connection mode (sometimes also referred to herein as the ‘first communication connection’) with the client device 120 through the gateway 201.

Alternatively, or additionally, the plug-in service 140 may determine (224) the target communication connection mode between the predetermined plug-in and the client device 120 based on the communication identification in the call request. The plug-in service 140 may call the predetermined plug-in before the long connection is established, and then establish the long connection between the plug-in service 140 and the client device 120. The plug-in service 140 may also call the predetermined plug-in after the long connection is established.

In some embodiments of the present disclosure, as illustrated in the signaling flow 200, the plug-in service 140 calls (226) the predetermined plug-in, and performs one or more communications with client device 120 with the call parameters via the long connection, to request the client device 120 to execute the target function. The client device 120 receives, via the long connection, the call parameter for the target function at the client device 120 from the plug-in service 140. The client device 120 executes the target function based on the call parameter.

Alternatively, or additionally, the plug-in service 140 may perform one communication with the client device 120 with the call parameter to complete execution of the target function. The plug-in service 140 may also perform a plurality of communications with the client device 120 with the call parameter to complete execution of the target function.

For example, as illustrated in FIG. 2, the plug-in service 140 may call the predetermined plug-in to send (230) Message A to the client device 120 via the long connection. The Message A may include at least part of the call parameter and other content as well. In response to receiving (232) the Message A from the plug-in service 140, the client device 120 executes (234) Operation A. Thereafter, the client device 120 sends (236) Feedback A to the plug-in service 140 via the long connection. The Feedback A may include the execution result of Operation A. Certainly, Feedback A may also include other information.

In response to receiving (238) Message A from the client device 120, the plug-in service 140 may send (240) Message B to the client device 120. The Message B may also include at least part of the call parameter. In response to receiving (242) Message B from the plug-in service 140, the client device 120 may execute (244) Operation B. Thereafter, the client device 120 may send (246) Feedback B to the plug-in service 140. The Feedback B may include the execution result of Operation B. Certainly, Feedback B may also include other information.

It may be understood that the foregoing communication process is merely presented as an example. To request client device 120 to execute the target function, the plug-in service 140 may need to perform one communication with the client device 120, or perform more than two communications.

In some embodiments, the client device 120 may determine whether there is an authorization to execute the target function by the client device. In response to determining that there is an authorization, the target function may be executed based on the call parameter. When there is no authorization, the client device 120 may send a notification to the server device 120, informing, through the notification, the server device 110 that there is no authorization to execute the target function by the client device 120. Alternatively, the client device 120 may also present the notification, informing the user 150 that there is no authorization to execute the target function by the client device 120, so as to request the user 150 to perform the authorization operation.

In some embodiments, when the plug-in service 140 determines that the execution condition of the target function includes the need to have authorization to execute the target function by the client device 120, the plug-in service 140 may send an authorization request to the client device 120 via the communication connection. The authorization request is configured to request authorization to execute the target function by the client device. In response to receiving the authorization operation to execute the target function by the client device 120, the client device 120 may send the authorization of executing the target function by the client device to the plug-in service 140. In response to receiving the authorization, the plug-in service 140 may request, via the communication connection, the client device 120 to execute the target function with the call parameter.

For example, “message a” sent by the plug-in service 140 to client device 120 may include the authorization request. In response to receiving “message a” the client device 120 may present a notification page for notifying the user 150 to authorize the target function. In response to user 150's authorization operation (e.g., operation b) for executing the target function by the client device 120, the client device 120 may send “feedback a” to the plug-in service. The “feedback a” may include the authorization to execute the target function by the client device 120. In response to receiving the authorization, the plug-in service 140 may send “message b” to the client device 120. The “message b” may include at least part of the call parameter. The client device 120 may execute “operation b” based on the call parameter, to achieve the target function (e.g., volume adjustment function, brightness adjustment function, etc.).

In some embodiments of the present disclosure, as illustrated in the signaling flow 200, the client device 120 returns the execution result of the target function to the plug-in service 140 via the long connection. The plug-in service 140 provides (250) the execution result of the target function to the server device 110. In response to receiving (252) the execution result, the server device 110 provides (254) the execution result to the machine learning model 130. The machine learning model 130 receives (256) the execution result from the server device 110, and then generates (258) the response 262 to the interaction information. The machine learning model 130 returns (264) the response 262 to the server device 110, and the server device 110 provides (266) the response 262 to the client device 120. In response to receiving (268) the response 262 to the interaction information from the server device 110, the client device 120 may present the response 262. The response 262 at least indicates the execution result of the target function.

Alternatively, or additionally, the client device 120 provides one or more execution results of the target function to the plug-in service 140 via the long connection. For example, to achieve the target function, the client device 120 may be configured to execute one or more operations. The client device 120 may be configured to provide the execution result (e.g., feedback a, feedback b) of each operation after the execution of each operation is completed. The client device 120 may also be configured to provide the execution result of the target function to the plug-in service after the executions of one or more operations of the target function are completed.

Alternatively, or additionally, the response 262 here may be configured to indicate that the execution of target function is completed, the execution of target function fails, or the execution of target function is partially completed. For example, the user 150 may talk to the digital assistant 121 and input the user voice ‘please increase the volume’ to the digital assistant 121. After the plug-in service 140 calls the predetermined plug-in to request the client device 120 to complete the volume adjustment, the server device 110 may provide the execution result of the volume adjustment to the machine learning model 130. The machine learning model 130 may generate the response text or the response voice (for example, ‘volume has been adjusted’ or ‘volume has been increased’, etc.). The server device 110 may feed back the response text or the response voice to the client device 120. The client device 120 may present the response text and/or play the response voice.

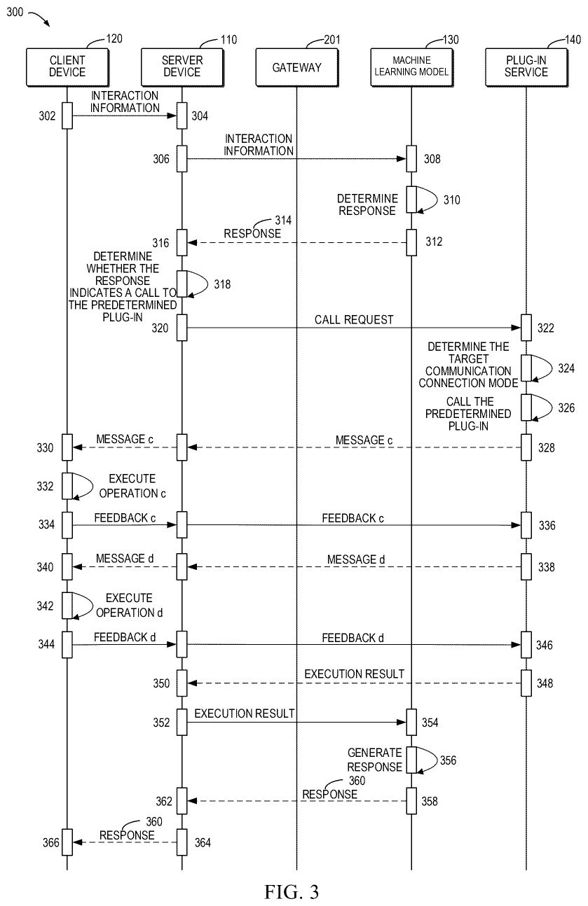

FIG. 3 illustrates a flowchart of a signaling flow 300 for plug-in processing according to some embodiments of the present disclosure. The signaling flow 300 involves the client device 120, the server device 110, the gateway 201, the machine learning model 130, and the plug-in service 140. It will be appreciated that the main difference between the signaling flow 300 and the signaling flow 200 is that the plug-in service 140 and the client device 120 communicate via a short connection. The other processes in the signaling flow 300 are similar to the signaling flow 200. Therefore, the process of communicating using the short connection in the signaling flow 300 will be described in detail below with reference to the environment 100 of FIG. 1, and for other processes, reference may be made to the description of the signaling flow 200.

In some embodiments of the present disclosure, as illustrated in the signaling flow 300, in response to receiving the interaction information of the user 150, the client device 120 sends (302) the interaction information to the server device 110. In response to receiving (304) the interaction information of the user 150 from the client device 120, the server device 110 provides (306) the interaction information to the machine learning model 130. The machine learning model 130 receives (308) the interaction information provided by the server device 110, determines (310) the response 314 to the interaction information, and feeds back (312) the response 314 to the server device 110.

In some embodiments of the present disclosure, as illustrated in the signaling flow 300, the server device 110 receives (316) the response 314 from the machine learning model 130. The server device 110 determines (318) whether the response 314 indicates the call to the predetermined plug-in. When the response 314 includes the call indication of the predetermined plug-in, the call parameter for the target function of the at least one function and the target communication connection mode with client device 120, the server device 110 sends (320) the call request to the plug-in service 140.

In embodiments of the present disclosure, as illustrated in the signaling flow 300, in response to receiving (322) the call request from server device 110, the plug-in service 140 determines (324) the target communication connection mode with the client device 120. When the target communication connection mode indicates the short connection mode, the plug-in service 140 establishes the short connection (sometimes also referred to as a “second communication connection”) between the server device 110 and the client device 120 for at least one time. The plug-in service 140 performs a communication with the client device 120 with the call parameter via the short connection established each time. The client device 120 performs a communication with the plug-in service 140 via the short connection established each time, to receive the call parameter from the plug-in service 140. The client device 120 executes the target function based on the call parameter.

The short connection here may be a short connection conforming to the TCP protocol. For the short connection, only one communication may be performed each time it is established. When one communication is required to request the client device 120 to execute the target function, then only a single short connection needs to be established between the plug-in service 140 and the client device 120 via the server device 110. When a plurality of communications are required to request the client device 120 to execute the target function, then a plurality of short connections need to be established between the plug-in service 140 and the client device 120. Each time the short connection is established, a communication is performed, and then the established short connection is disconnected.

For example, as illustrated in FIG. 3, the plug-in service 140 may establish a short connection with the client device 120 via the server device 110. The plug-in service 140 may send (328) “message c” to the client device 120 based on the short connection. In response to receiving (330) “message c” from the plug-in service 140, the client device 120 may execute (332) “operation c.” Thereafter, the client device 120 may establish the short connection with the plug-in service 140 again via the server device 110. The client device 120 may send (334) “feedback c” to the plug-in service 140 via the short connection. After “feedback c” is sent, the short connection is disconnected again.

In response to receiving (336) “feedback c”, the plug-in service 140 may establish the short connection with the client device 120 again, and send (338) “message d” to the client device 120 via the short connection, and then disconnect the short connection again. In response to receiving (340) “message d” from the plug-in service 140, the client device 120 may execute (342) “operation d.” The client device 120 establishes the short connection with the plug-in service 140 again, and sends (344) “feedback d” to the plug-in service 140 via the short connection.

In some embodiments, each message communicated between the server device 110 and the client device 120 via the short connection (sometimes also referred to herein as the “second communication connection”) includes an identifier to identify current execution of the target function. As such, in a case where a plurality of communications need to be performed between the server device 110 and the client device 120 based on the short connection, the server device 110 and the client device 120 may determine information related to the target function based on the identifier.

For example, as illustrated in FIG. 3, “message c” and “message d” may include the same identifier. After the client device 120 receives (340) “message d,” it may find “feedback c” based on the identifier, and obtain the execution result of “operation c.” Then, the client device 120 may execute “operation d” based on “message d” and “feedback c.” In this way, the continuous execution of the target function may also be ensured in the case of communication via the short connection.

In some embodiments of the present disclosure, as illustrated in the signaling flow 300, the client device 120 provides the execution result of the target function to the plug-in service 140 via the long connection. The plug-in service 140 provides (348) the execution result of the target function to the server device 110. In response to receiving (350) the execution result, the server device 110 provides (352) the execution result to the machine learning model 130. After receiving (354) the execution result from the server device 110, the machine learning model 130 generates (356) the response 360 to the interaction information. The machine learning model 130 provides (362) the response 360 to the server device 110. The server device 110 provides (364) the response 360 to the client device 120. In response to receiving (366) the response 360 from the server device 110, the client device 120 presents the response 360 to the interaction information. The response 360 here at least indicates the execution result of the target function.

Alternatively, or additionally, to achieve the target function, the client device 120 may be configured to execute one or more operations. The client device 120 may be configured to provide the execution result of each operation to the plug-in service 140 after the execution of each operation is completed. The client device 120 may also be configured to provide the execution result of the target function to the plug-in service after the executions of the one or more operations of the target function are completed.

The plug-in service 140 may send the execution result for the operation to the server device 110 after it receives the execution result for the operation each time. After the execution of the target function is completed, the server device 110 may combine the execution results of the plurality of operations to form the execution result for the target function based on the identifier. Then, the execution result of the target function is sent to the machine learning model 130.

After the execution of the target function is completed, the plug-in service 140 may also combine the execution results of the plurality of operations to form the execution result for the target function based on the identifier. Then, the execution result of the target function is sent to the server device 110.

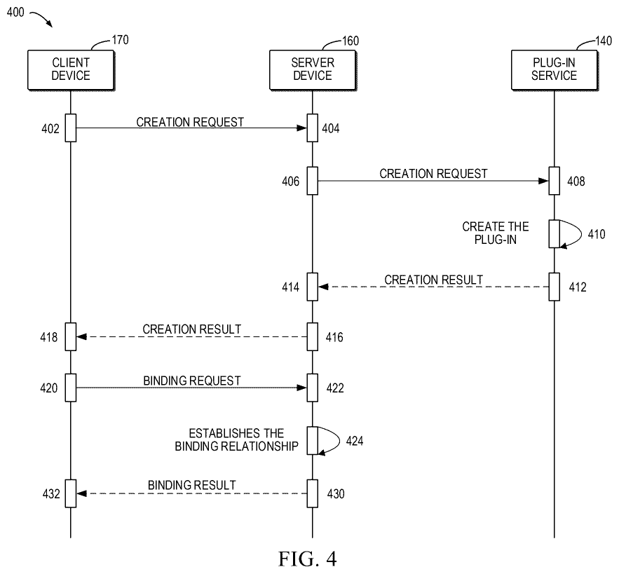

In order to facilitate understanding of the creation process of the plug-in, the creation process of the plug-in will be described below with reference to FIG. 4. FIG. 4 illustrates a flowchart of a signaling flow 400 for plug-in processing according to some embodiments of the present disclosure. The signaling flow 400 involves the client device 170, the server device 160, and plug-in service 140. For ease of discussion, the signaling flow 400 will be described with reference to environment 100 of FIG. 1.

In some embodiments of the present disclosure, as illustrated in the signaling flow 400, in response to the developer's (e.g., the user 180) operation of creating the plug-in, the client device 170 sends (402) a creation request to create the plug-in to the server device 160. After the server device 160 receives (404) the creation request from the client device 170, the server device 160 requests (406) the plug-in service 140 to create (410) the plug-in. The plug-in service 140 returns (412) the creation result of the plug-in to the server device 160. In response to receiving (414) the creation result of the plug-in, the server device 160 provides (416) the creation result of the plug-in to the client-side device 170.

Alternatively, or additionally, the developer may enter information such as plug-in definition into the plug-in creation platform via the client device 170 or the attachment device of the client device 170. The plug-in definition may include, but is not limited to, the name field, the address field, the description field, the input parameter, the output parameter, the communication identification, etc. of the plug-in. The communication identification may be configured to identify the target communication connection mode adopted by the plug-in.

Alternatively, or additionally, the creation request may carry information such as the above plug-in definition. The server device 160 may also send the plug-in creation page to the client device 170 in response to the creation request. The developer may enter the plug-in definition information into the plug-in creation page.

Alternatively, or additionally, the plug-in service 140 may be deployed with a database. The plug-in service 140 creates the plug-in based on information such as the plug-in definition described above. Then, the plug-in service 140 may store the created plug-in in the database for subsequent calls.

In some embodiments of the present disclosure, as illustrated in signaling flow 400, in response to receiving (418) the creation result indicating that plug-in creation is completed, the client device 170 may send (420) a binding request to the server device 160. The binding request here is configured to request the server device 160 to establish a binding relationship between the digital assistant 121 and the plug-in.

In some embodiments of the present disclosure, as illustrated in signaling flow 400, in response to receiving (422) the binding request from the client device 170, the server device 160 establishes (424) the binding relationship between the digital assistant and the plug-in. The server device 160 may return (430) the binding result of the binding relationship to the client device 170. In response to receiving (432) the binding result, the client device 170 may present the binding result.

Alternatively, or additionally, after the plug-in service 140 completes the creation of the plug-in, the plug-in service 140 may generate a plug-in number to identify the plug-in. The plug-in service 140 may send the plug-in number to the client device 170 via the server device 160. For example, the creation result of the plug-in may include the plug-in number. The client device 170 may send the binding request to the server device 160 based on the plug-in number. The server device 160 may establish the corresponding binding relationship between the plug-in and the digital assistant 121 based on the plug-in number, such that the digital assistant 121 may call the plug-in to provide services for the user.

In conclusion, according to embodiments of the present disclosure, the plug-in may be used to request the client device to execute the target function, which is beneficial for expanding the usage function and the service capability of the digital assistant.

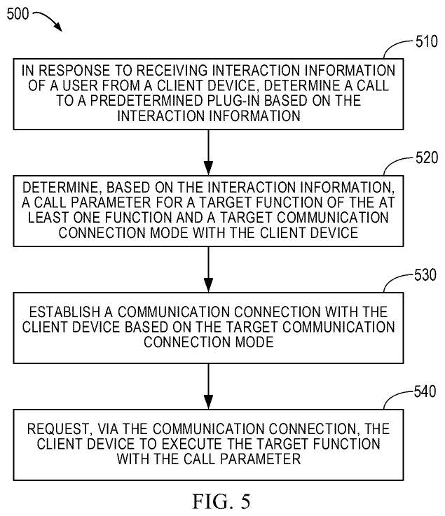

FIG. 5 illustrates a flowchart of a process 500 for plug-in processing according to some embodiments of the present disclosure. The process 500 may be implemented at the server device 110.

At block 510, in response to receiving interaction information of a user from a client device, a call to a predetermined plug-in is determined based on the interaction information. The predetermined plug-in is configured to request execution of at least one function at the client device.

At block 520, a call parameter for a target function of the at least one function and a target communication connection mode with the client device are determined based on the interaction information.

At block 530, a communication connection is established with the client device based on the target communication connection mode.

At block 540, the client device is requested to execute the target function with the call parameter via the communication connection.

In some embodiments, requesting the client device to execute the target function with the call parameter includes: sending an authorization request to the client device via the communication connection, the authorization request being configured to request authorization to execute the target function by the client device; and in response to receiving the authorization to execute the target function by the client device, requesting, via the communication connection, the client device to execute the target function with the call parameter.

In some embodiments, the target communication connection mode indicates a long connection mode. Requesting the client device to execute the target function with the call parameter includes: performing, via a first communication connection corresponding to the long connection mode, one or more communications with the client device with the call parameter, to complete execution of the target function.

In some embodiments, the target communication connection mode indicates a short connection mode. Establishing the communication connection with the client device includes: establishing, based on the short connection mode, a second communication connection between the server device and the client device for at least one time. Requesting the client device to execute the target function with the call parameter includes: performing, via the second communication connection established each time, a communication with the client device with the call parameter, to complete execution of the target function.

In some embodiments, each message communicated between the server device and the client device via the second communication connection includes an identifier to identify current execution of the target function.

In some embodiments, the process 500 further includes: receiving an execution result of the target function from the client device; and sending, to the client device, a response to the interaction information. The response at least indicates the execution result of the target function.

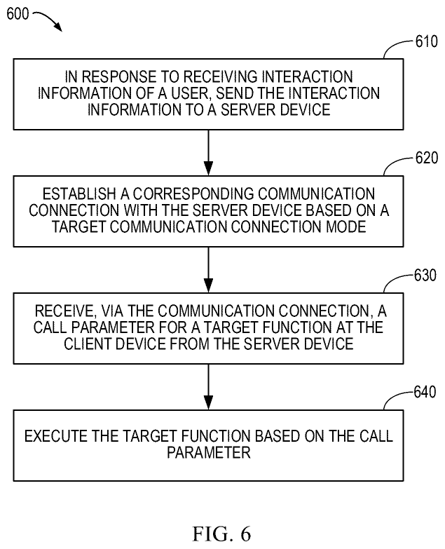

FIG. 6 shows a flowchart of a process 600 for plug-in processing according to some embodiments of the present disclosure. The process 600 may be implemented at the client device 120.

At block 610, in response to receiving the interaction information of the user, the interaction information is sent to the server device.

At block 620, a corresponding communication connection is established with the server device based on the target communication connection mode.

At block 630, a call parameter for a target function at a client device is received from the server device via the communication connection.

At block 640, the target function is executed based on the call parameter.

In some embodiments, executing the target function based on the call parameter includes: determining whether there is an authorization to execute the target function by the client device; and in response to there being the authorization, executing the target function based on the call parameter.

In some embodiments, the process 600 further includes: receiving an authorization request from the server device via the communication connection; and in response to receiving an authorization operation to execute the target function by the client device, sending, to the server device, an authorization to execute the target function by the client device. The authorization request is configured to request authorization of executing the target function by the client device.

In some embodiments, the target communication connection mode indicates a long connection mode. Receiving the call parameter for the target function at the client device from the server device includes: performing, via a first communication connection corresponding to the long connection mode, one or more communications with the server device, to receive the call parameter from the server device.

In some embodiments, the target communication connection mode indicates a short connection mode. Establishing the corresponding communication connection with the server device based on the target communication connection mode includes: establishing, based on the short connection mode, a second communication connection between the client device and the server device for at least one time. Receiving the call parameter for the target function at the client device from the server device includes: performing, via the second communication connection established each time, a communication with the server device, to receive the call parameter from the server device.

In some embodiments, each message communicated between the server device and the client device via the second communication connection includes an identifier to identify current execution of the target function.

In some embodiments, the process 600 further includes: providing an execution result of the target function to the server device; and in response to receiving a response to the interaction information from the server device, presenting the response, the response at least indicating the execution result of the target function.

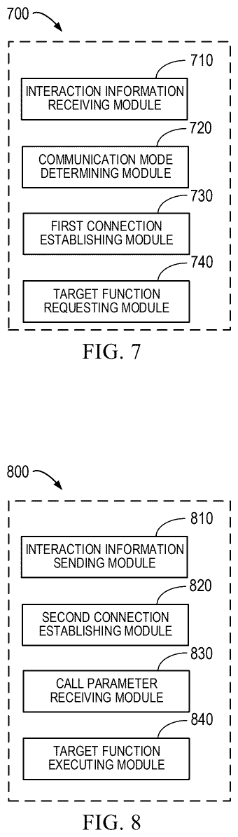

Embodiments of the present disclosure also provide corresponding apparatus for implementing the above methods or processes. FIG. 7 illustrates an example structural block diagram of an apparatus 700 for plug-in processing according to some embodiments of the present disclosure. The apparatus 700 may be implemented as the server device 110 or included in the server device 110. The various modules/components in the apparatus 700 may be implemented by hardware, software, firmware, or any combination thereof.

As illustrated in FIG. 7, the apparatus 700 includes an interaction information receiving module 710, a communication mode determining module 720, a first connection establishing module 730 and a target function requesting module 740. The interaction information receiving module 710 is configured to in response to receiving interaction information of a user from a client device, determine a call to a predetermined plug-in based on the interaction information. The predetermined plug-in is configured to request execution of at least one function at the client device. The communication mode determining module 720 is configured to determine, based on the interaction information, a call parameter for a target function of the at least one function and a target communication connection mode with the client device. The first connection establishing module 730 is configured to establish a communication connection with the client device based on the target communication connection mode. The target function requesting module 740 is configured to request, via the communication connection, the client device to perform the target function with the call parameter.

In some embodiments, the target function requesting module 740 is further configured to: send an authorization request to the client device via the communication connection; and in response to receiving the authorization to execute the target function by the client device, request, via the communication connection, the client device to execute the target function with the call parameter. The authorization request is configured to request authorization to execute the target function by the client device.

In some embodiments, the target communication connection mode indicates a long connection mode. The target function requesting module 740 is further configured to perform, via the first communication connection corresponding to the long connection mode, one or more communications with the client device with the call parameter, to complete execution of the target function.

In some embodiments, the target communication connection mode indicates a short connection mode. The first connection establishing module 730 is further configured to: establish, based on the short connection mode, a second communication connection between the server device and the client device for at least one time. The target function requesting module 740 is further configured to perform, via the second communication connection established each time, a communication with the client device with the call parameter, to complete the execution of the target function.

In some embodiments, each message communicated between the server device and the client device via the second communication connection includes an identifier to identify current execution of the target function.

In some embodiments, the apparatus 700 further includes an execution result receiving module. The execution result receiving module is configured to receive an execution result of the target function from the client device; and send, to the client device, a response to the interaction information. The response at least indicates the execution result of the target function.

It should be understood that one or more steps of the above methods may be performed by a suitable electronic device or combination of electronic devices. Such electronic devices or combinations of electronic devices may include, for example, the server device 110 in FIG. 1.

Embodiments of the present disclosure further provide corresponding apparatus for implementing the above methods or processes. FIG. 8 illustrates an example structural block diagram of an apparatus 800 for plug-in processing according to some embodiments of the present disclosure. The apparatus 800 may be implemented as the client device 120 or included in the client device 120. The various modules/components in the apparatus 800 may be implemented by hardware, software, firmware, or any combination thereof.

As illustrated in FIG. 8, the apparatus 800 includes an interaction information sending module 810, a second connection establishing module 820, a call parameter receiving module 830, and a target function executing module 840. The interaction information sending module 810 is configured to, in response to receiving interaction information of a user, send the interaction information to a server device. The second connection establishing module 820 is configured to establish a corresponding communication connection with the server device based on a target communication connection mode. The call parameter receiving module 830 is configured to receive, via the communication connection, a call parameter for a target function at the client device from the server device. The target function executing module 840 is configured to execute the target function based on the call parameter.

In some embodiments, the target function executing module 840 is further configured to: determine whether there is an authorization of executing the target function by the client device; and in response to there being the authorization, execute the target function based on the call parameter.

In some embodiments, the apparatus 800 further includes an authorization request receiving module. The authorization request receiving module is configured to receive an authorization request from the server device via the communication connection; and in response to receiving an authorization operation for executing the target function by the client device, send, to the server device, an authorization of executing the target function by the client device. The authorization request is configured to request authorization of executing the target function by the client device.

In some embodiments, the target communication connection mode indicates a long connection mode. The call parameter receiving module 830 is further configured to perform, via a first communication connection corresponding to the long connection mode, one or more communications with the server device, to receive the call parameter from the server device.

In some embodiments, the target communication connection mode indicates a short connection mode. The second connection establishing module 820 is further configured to establish, based on the short connection mode, a second communication connection between the client device and the server device for at least one time. The call parameter receiving module 830 is further configured to perform, via the second communication connection established each time, a communication with the server device, to receive the call parameter from the server device.

In some embodiments, each message communicated between the server device and the client device via the second communication connection includes an identifier to identify current execution of the target function.

In some embodiments, the apparatus 800 further includes an execution result feedback module. The execution result feedback module is configured to feed back an execution result of the target function to the server device; and in response to receiving a response to the interaction information from the server device, present the response. The response at least indicates the execution result of the target function.

It should be understood that one or more steps of the above methods may be performed by a suitable electronic device or combination of electronic devices. Such an electronic device or combination of electronic devices may include, for example, the client device 120 in FIG. 1.

The units and/or modules included in apparatus 700 and apparatus 800 may be implemented in a variety of ways, including software, hardware, firmware, or any combination thereof. In some embodiments, one or more units and/or modules may be implemented using software and/or firmware, such as machine-executable instructions stored on a storage medium. In addition to or as an alternative to machine executable instructions, some or all of the units and/or modules in apparatus 700 and 800 may be implemented, at least in part, by one or more hardware logic components. By way of example, and not limitation, illustrative types of hardware logic components that may be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

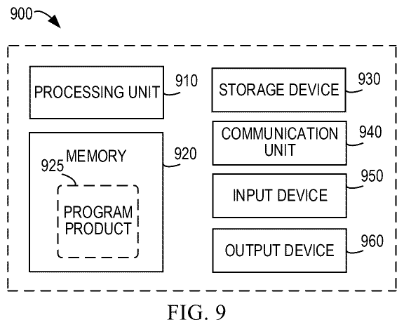

FIG. 9 illustrates a block diagram of an electronic device 900 in which one or more embodiments of the present disclosure may be implemented. It should be appreciated that the electronic device 900 illustrated in FIG. 9 is merely exemplary and should not constitute any limitation on the functionality and scope of the embodiments described herein. The electronic device 900 illustrated in FIG. 9 may be configured to implement the server device 110 or the client device 120 in FIG. 1, and the electronic device 900 may also be configured to implement the apparatus 700 in FIG. 7 or the apparatus 800 in FIG. 8.

As illustrated in FIG. 9, electronic device 900 is in the form of a general-purpose electronic device. The components of electronic device 900 may include, but are not limited to, one or more processors or processing units 910, a memory 920, a storage device 930, one or more communication units 940, one or more input devices 950, and one or more output devices 960. The processing unit 910 may be an actual or virtual processor and is capable of performing various processes according to programs stored in the memory 920. In a multiprocessor system, multiple processing units execute computer-executable instructions in parallel to improve the parallel processing capabilities of the electronic device 900.

Electronic device 900 typically includes a number of computer storage media. Such media may be any available media that may be accessed by electronic device 900, including, but not limited to, volatile and non-volatile media, removable and non-removable media. The memory 920 may be volatile memory (e.g., registers, cache, random access memory (RAM)), non-volatile memory (e.g., read-only memory (ROM), electrically erasable programmable read-only memory (EEPROM), flash memory), or some combination thereof. Storage device 930 may be a removable or non-removable medium and may include a machine-readable medium such as a flash drive, a magnetic disk, or any other medium that may be used to store information and/or data and that may be accessed within electronic device 900.

The electronic device 900 may further include additional removable/non-removable, volatile/non-volatile storage media. Although not illustrated in FIG. 9, a magnetic disk drive for reading or writing from to a removable, nonvolatile magnetic disk (e.g., “floppy disk”), and an optical disk drive for reading or writing from a removable, non-volatile optical disk may be provided. In these cases, each drive may be connected to a bus (not illustrated) by one or more data media interfaces. Memory 920 may include a computer program product 925 having one or more program modules configured to perform various methods or actions of various embodiments of the present disclosure.

The communication unit 940 implements communication with other electronic devices through a communication medium. In addition, functions of components of the electronic device 900 may be implemented by a single computing cluster or a plurality of computing machines, and these computing machines can communicate through a communication connection. Accordingly, the electronic device 900 may operate in a networked environment using logical connections to one or more other servers, a network personal computer (PC), or another network node.

Input device 950 may be one or more input devices such as a mouse, keyboard, trackball, etc. Output device 960 may be one or more output devices such as a display, speakers, printer, etc. The electronic device 900 may also communicate with one or more external devices (not illustrated), such as storage devices, display devices, etc., as needed through the communication unit 940, with one or more devices that enable a user to interact with the electronic device 900, or with any device (e.g., network card, modem, etc.) that enables the electronic device 900 to communicate with one or more other electronic devices. Such communication may be performed via an input/output (I/O) interface (not illustrated).

According to an example implementation of the present disclosure, a computer-readable storage medium is provided, on which computer-executable instructions are stored. The computer-executable instructions are executed by a processor to perform the above-described method. According to an exemplary implementation of the present disclosure, a computer program product is also provided. The computer program product is tangibly stored on a non-transitory computer-readable medium and includes computer-executable instructions that are executed by a processor to perform the method described above.

Aspects of the present disclosure are described herein with reference to flowchart illustrations and/or block diagrams of methods, apparatus, devices and computer program products implemented in accordance with the present disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/acts specified in the flowchart and/or block diagram block or blocks. These computer-readable program instructions may also be stored in a computer-readable storage medium that can direct a computer, programmable data processing apparatus, and/or other devices to function in a particular manner, such that the computer-readable medium storing the instructions includes an article of manufacture including instructions which implement various aspects of the functions/acts specified in the flowchart and/or block diagram block or blocks.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions which execute on the computer, other programmable data processing apparatus, or other devices implement the functions/acts specified in the flowchart and/or block diagram block or blocks.

The flowcharts and block diagrams in the accompanying drawings illustrate possible architectures, functions, and operations of systems, methods, and computer program products according to various implementations of the present disclosure. In this regard, each block in the flowchart or block diagrams may represent a module, a program segment, or a portion of an instruction, which includes one or more executable instructions for implementing a specified logical function. In some updated implementations, the functions marked in the boxes may also occur in an order different from that marked in the accompanying drawings. For example, two consecutive blocks may actually be executed substantially in parallel, and they may sometimes be executed in the opposite order, depending on the functions involved. It should also be noted that each block in the block diagram and/or flowchart, and the combination of blocks in the block diagram and/or flowchart, may be implemented using a dedicated hardware-based system that performs the specified function or action, or may be implemented using a combination of dedicated hardware and computer instructions.

The above descriptions of various implementations of the present disclosure are exemplary, non-exhaustive, and not limited to the disclosed implementations. Without departing from the scope and spirit of the illustrated implementations, many modifications and variations will be apparent to those of ordinary skill in the art. The selection of terms used herein is intended to best explain the principles of the various implementations, practical applications, or improvements to the technology in the market, or to enable other persons of ordinary skill in the art to understand the various implementations disclosed herein.

What is claimed is:

1. A method for plug-in processing, applied at a server device, the method comprising:
in response to receiving interaction information of a user from a client device, determining a call to a predetermined plug-in based on the interaction information, the predetermined plug-in being configured to request execution of at least one function at the client device;
determining, based on the interaction information, a call parameter for a target function of the at least one function and a target communication connection mode with the client device;
establishing a communication connection with the client device based on the target communication connection mode; and
requesting, via the communication connection, the client device to execute the target function with the call parameter.

2. The method of claim 1, wherein requesting the client device to execute the target function with the call parameter comprises:
sending an authorization request to the client device via the communication connection, the authorization request being configured to request authorization to execute the target function by the client device; and
in response to receiving the authorization to execute the target function by the client device, requesting, via the communication connection, the client device to execute the target function with the call parameter.

3. The method of claim 1, wherein the target communication connection mode indicates a long connection mode, and wherein requesting the client device to execute the target function with the call parameter comprises:
performing, via a first communication connection corresponding to the long connection mode, one or more communications with the client device with the call parameter, to complete execution of the target function.

4. The method of claim 1, wherein the target communication connection mode indicates a short connection mode, and wherein establishing the communication connection with the client device comprises:
establishing, based on the short connection mode, a second communication connection between the server device and the client device for at least one time; and
wherein requesting the client device to execute the target function with the call parameter comprises:
performing, via the second communication connection established each time, a communication with the client device with the call parameter, to complete execution of the target function.

5. The method of claim 4, wherein each message communicated between the server device and the client device via the second communication connection comprises an identifier to identify current execution of the target function.

6. The method of claim 1, further comprising:
receiving an execution result of the target function from the client device; and
sending, to the client device, a response to the interaction information, the response at least indicating the execution result of the target function.

7. A method for plug-in processing, applied at a client device, the method comprising:
in response to receiving interaction information of a user, sending the interaction information to a server device;
establishing a corresponding communication connection with the server device based on a target communication connection mode;
receiving, via the communication connection, a call parameter for a target function at the client device from the server device; and
executing the target function based on the call parameter.

8. The method of claim 7, wherein executing the target function based on the call parameter comprises:
determining whether there is an authorization to execute the target function by the client device; and
in response to there being the authorization, executing the target function based on the call parameter.

9. The method of claim 7, further comprising:
receiving an authorization request from the server device via the communication connection, the authorization request being configured to request authorization to execute the target function by the client device; and
in response to receiving an authorization operation to execute the target function by the client device, sending, to the server device, an authorization to execute the target function by the client device.

10. The method of claim 7, wherein the target communication connection mode indicates a long connection mode, and wherein receiving the call parameter for the target function at the client device from the server device comprises:
performing, via a first communication connection corresponding to the long connection mode, one or more communications with the server device, to receive the call parameter from the server device.

11. The method of claim 7, wherein the target communication connection mode indicates a short connection mode, and wherein establishing the corresponding communication connection with the server device based on the target communication connection mode comprises:
establishing, based on the short connection mode, a second communication connection between the client device and the server device for at least one time; and
wherein receiving the call parameter for the target function at the client device from the server device comprises:
performing, via the second communication connection established each time, a communication with the server device, to receive the call parameter from the server device.

12. The method of claim 11, wherein each message communicated between the server device and the client device via the second communication connection comprises an identifier to identify current execution of the target function.

13. The method of claim 7, further comprising:
providing an execution result of the target function to the server device; and
in response to receiving a response to the interaction information from the server device, presenting the response, the response at least indicating the execution result of the target function.

14. An electronic device, comprising:
at least one processing unit; and
at least one memory coupled to the at least one processing unit and storing instructions for execution by the at least one processing unit that, when executed by the at least one processing unit, cause the electronic device to perform operations comprising:
in response to receiving interaction information of a user from a client device, determining a call to a predetermined plug-in based on the interaction information, the predetermined plug-in being configured to request execution of at least one function at the client device;
determining, based on the interaction information, a call parameter for a target function of the at least one function and a target communication connection mode with the client device;
establishing a communication connection with the client device based on the target communication connection mode; and
requesting, via the communication connection, the client device to execute the target function with the call parameter.

15. The electronic device of claim 14, wherein requesting the client device to execute the target function with the call parameter comprises:
sending an authorization request to the client device via the communication connection, the authorization request being configured to request authorization to execute the target function by the client device; and
in response to receiving the authorization to execute the target function by the client device, requesting, via the communication connection, the client device to execute the target function with the call parameter.

16. The electronic device of claim 14, wherein the target communication connection mode indicates a long connection mode, and wherein requesting the client device to execute the target function with the call parameter comprises:
performing, via a first communication connection corresponding to the long connection mode, one or more communications with the client device with the call parameter, to complete execution of the target function.

17. The electronic device of claim 14, wherein the target communication connection mode indicates a short connection mode, and wherein establishing the communication connection with the client device comprises:
establishing, based on the short connection mode, a second communication connection between the server device and the client device for at least one time; and
wherein requesting the client device to execute the target function with the call parameter comprises:
performing, via the second communication connection established each time, a communication with the client device with the call parameter, to complete execution of the target function.

18. The electronic device of claim 17, wherein each message communicated between the server device and the client device via the second communication connection comprises an identifier to identify current execution of the target function.

19. The electronic device of claim 14, the operations further comprising:
receiving an execution result of the target function from the client device; and
sending, to the client device, a response to the interaction information, the response at least indicating the execution result of the target function.
